(19) United States
(12) Patent Application Publication
(10) Pub. No.: US 2016/0078498 A1
(43) Pub. Date: Mar. 17, 2016

(54) METHOD AND SYSTEM FOR PURCHASING GOODS ON INTERNET

(71) Applicant: GRAFFITI 2000 S.R.L., Riva del Garda (IT)

(72) Inventor: Luca CATTOI, Riva del Garda (TN) (IT)

(73) Assignee: GRAFFITI 2000 S.R.L., Riva del Garda (IT)

(21) Appl. No.: 14/852,846

(22) Filed: Sep. 14, 2015

(30) Foreign Application Priority Data
Sep. 15, 2014 (IT) VI2014A000234

(51) Int. Cl. G06Q 30/02; G06Q 30/06

(52) U.S. Cl. CPC G06Q 30/0277; G06Q 30/0633

(57) ABSTRACT

A method and a system for purchasing goods on Internet, which allows publishers who handle blogs and websites, write articles and review products, to sell products directly on their own website, thus making it extremely simple for the user to acquire what he/she sees. Specifically, the websites of publishers offer, within the various articles, different types of “objects”, such as photo-galleries, text-links, single images, banners, buttons and widgets, and the program software allows an “action” to be integrated on such “objects”, that is a step of activating the acquisition process of a specific product, which can be chosen by the publisher of the website or selected by means of a “machine learning” algorithm capable of semantically determining the best product on the basis of different parameters, such as page URL, behaviour and preferences of the users on that page, percentage of clicks on products shown previously for sale, etc.

### CROSS REFERENCE TO RELATED APPLICATIONS

This application is based upon and claims the benefit of priority from the prior Italian Patent Application No. VI2014A000234, filed on Sep. 15, 2014, the entire contents of which are incorporated herein by reference.

### FIELD

The present invention relates in general to a method and relative system for purchasing goods on Internet, and more specifically relates to a purchasing or acquisition process which allows publishers who handle blogs and websites, write articles and review products, to sell products directly on their own website, thus making it extremely simple for the user to acquire what he/she sees.

According to the invention, websites of publishers offer, within the various articles, different types of “objects”, such as photo-galleries, text-links, single images, banners, buttons and widgets, and the program software which supervises the system allows an “action” to be integrated on such “objects”, that is the activation of the process for acquiring a specific product which can be chosen by the publisher of the website or selected by means of a “machine learning” algorithm capable of semantically determining the best product on the basis of different parameters, such as page URL, behaviour and preferences of the users on that page, percentage of clicks on products shown previously for sale, etc.

### BACKGROUND

There are currently many specialised and generic websites offering products for sale to users, who can acquire the product directly online by means of Internet, with substantially secure payment systems and consolidated methods for delivering the product to the address indicated.

However, such traditional online selling and purchasing systems do not allow an individual to sell third-party products on his/her own website pages, nor do they allow such an individual to manually or automatically (by means of dedicated algorithms) select such products.

It is therefore the object of the present invention to create a system for purchasing goods on Internet, which allows publishers who handle blogs and websites, write articles and/or review products, to sell specific products directly on their own website, thus making it extremely simple for the user to acquire what he/she sees online.

Another object of the present invention is the one of creating a system for purchasing goods on Internet, which allows activating the process for purchasing a specific product directly within the various articles offered by the publisher.

Another object of the present invention is the one of creating a system and a method for purchasing goods on Internet, which allows the publisher to sell third-party products on his/her own web pages by adding a function for activating the purchasing process on said products selected manually or automatically, which are offered on the web pages.

A further object of the invention is the one of creating a system for purchasing goods on Internet, which allows the user and beneficiary of the website to quickly acquire the products selected by means of a few actions and directly within the user environment, that is to say within the site of the publisher.

These and other objects are achieved by a method for purchasing goods on Internet, and by a system for implementing the aforesaid method.

### DETAILED DESCRIPTION

Advantageously, the system according to the invention allows publishers, who handle blogs and websites, to sell third-party products on their own web pages by adding a purchasing process on the products selected manually or automatically (by means of a “machine learning” algorithm) and offered on the web pages, thus providing the user of the website the opportunity to acquire them with a few clicks and directly within the user environment.

The entire purchasing process is kept within the website of the publisher (and not on third-party sites), and therefore within a loyalty marketed environment for the user/reader and characterised by extreme purchasing simplicity and speed (with maximum two steps for the acquisition and without using a cart, because this system favours the 1 product-1 acquisition method).

The environment is loyalty marketed because the user who reads a specific article or visits a specific website of a given publisher and/or blogger is extremely loyal to this site.

Further features and advantages of the present invention will be more apparent from the following description relative to a preferred embodiment of the system and of the method herein claimed, given by way of non-limiting example, according to the present invention More specifically, the purchasing process relative to the system and to the method the object of the invention, according to that described hereinafter, is particularly simple and intuitive for the user.

Indeed, the user or reader who reads an article, scrolls through a gallery or simply accesses and surfs the website of the publisher can find a button, a widget or another type of object (text-link, image gallery, single image, banner, etc.) which, by highlighting the purchasing opportunity, promotes the product selected by the publisher.

The publisher has two methods for selecting the product made as a present or to be sold: manually, that is directly by choosing from a list of products loaded onto a prefixed service platform of “content service provider”, or automatically by means of a “machine learning” algorithm, which is handled by the aforesaid service platform and which is capable of semantically determining one or more products to be placed for sale on the basis of different parameters, such as the page URL, the users' behaviour on said page, the percentage of clicks on products previously shown for sale.

When the user or reader clicks on the object (button, widget, banner, single image, text-link, photo-gallery, etc.), a call is made to the provider platform, which loads the information relative to that product and then allows the user to acquire it (made as a present or by means of a true purchase) after having inserted his/her data.

In practice, by clicking on the object, the user requests the features of that product and, to this end, a window in i-frame (handled by the provider platform) appears on the screen with the features and the details of the product selected that the user is getting ready to acquire (such features can also include information concerning sizes, colours, etc.).

The same window handled by the provider platform is also used to request information concerning the shipping address and the payment method and once all fields have been completed, the user is ready to proceed with the acquisition by clicking on a specific confirmation button.

Another window, which is also handled by the provider platform, informs the user that the acquisition and/or purchase was successful and possibly provides a tracking code for tracking the shipment.

At the same time, the provider platform can send a further notice of the successful acquisition by means of e-mail and notice on a specific APP.

The “content service provider” platform includes an administrative office (separate for each publisher) for the products to be sold and/or to make as a present, where it is established which products are to be put on the list, their details (colours, sizes, etc.), the prices, the shipping costs and everything concerning the product in itself, while the publisher is responsible for inserting the purchasing tags on his/her own site, together with a specific script, which allows the purchasing process according to the invention to be launched and the web page to be populated with the objects on which the activation is to be integrated of such a purchasing process by referring to the products he/she directly chose or selected automatically by the “machine learning” algorithm.

Thereby, the sale and acquisition of the products is completely transparent to the publisher and on the other hand, the operation of the entire system is based on a program software owned and created by the “content service provider”.

It is therefore understood from the description above how the specific features are apparent of the system and of the method for purchasing goods on Internet the subject of the present invention, as are apparent the advantages resulting therefrom.

Lastly, it is apparent that numerous variants can be made to the system and to the purchasing method under examination without departing from the principles of novelty inherent to the inventive idea, as it is apparent that any materials, shapes and dimensions of the details illustrated in the practical implementation of the invention can be implemented on the basis of needs, and can be replaced with other technically equivalent ones.

1. A method for purchasing goods on Internet, according to which a user/reader acquires at least one product directly over a website which is handled by publishers who handle blogs and websites, write articles and/or review products, comprising:
accessing to said website which is handled by said publisher by the user/reader;
selecting a plurality of products to be offered on said website by the publisher;
showing on said website, within the articles of said publisher, different types of objects, including at least one of photo-galleries, text-links, single images, banners, buttons, and widgets, which are able to promote one or more products, by a program software;
activating, in correspondence of said objects, a step of acquisition of a product, by the user/reader, through a selection phase;
showing to said user/reader one or more features of said product;
filling by the user/reader the fields needed to proceed with the acquisition of said product;
confirming by the user/reader the acquisition of the product;
showing said acquisition of the product or of any anomalies to said user/reader.

2. The method according to claim 1, wherein said publisher selects said products directly by choosing from a list of products loaded onto a prefixed service platform, which is handled by a provider, or said publisher selects said products automatically with an algorithm, which is handled by said service platform and which allows selecting one or more products according to different parameters, including at least one of an the Internet page URL, behavior of the user/reader on said page, and a percentage of clicks on products previously shown for sale.

3. The method according to claim 2, wherein said service platform, which handles said program software, is configured to load and to show on a PC screen of the user/reader features of the selected product and allows the user/reader, after having inserted their data, to acquire the selected product.

4. The method according to claim 3, wherein said service platform is configured to show on the PC screen of said user/reader at least one first window which contains the characteristics of said selected product, including at least one of sizes and colors.

5. The method according to claim 4, wherein said first window includes a plurality of fields to be filled by the user/reader with additional information, including at least one of a the shipping address and a payment method.

6. The method according to claim 5, wherein a second window, which is handled by said service platform, gives information to said user/reader of the successful acquisition by at least one of e-mail and an APP notification.

7. The method according to any one of claim 2, wherein said service platform includes an administrative office, which is different for each publisher and which schedules the products to be placed on said websites, their features, prices, and shipping costs.

8. The method according to claim 1, wherein said publisher enters a list of purchasing tags on their website, along with a specific script, thus placing said objects on said website on which said step of acquisition of said products is activated, so that said acquisition of products is totally clear to said publisher.

9. A system for purchasing goods on Internet which implements a method according to claim 1.
